(19) United States
(12) Patent Application Publication
(10) Pub. No.: US 2010/0121942 A1
(43) Pub. Date: May 13, 2010

(54) Content Reproduction Device and Content Reproduction Method

(76) Inventors: Shinichi Ooi, Ome-shi (JP); Michihiro Fukushima, Fuchu-shi (JP)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 12/615,485

(22) Filed: Nov. 10, 2009

(30) Foreign Application Priority Data
Nov. 12, 2008 (JP) 2008-290224

(51) Int. Cl. G06F 15/16

(52) U.S. Cl. 709/219

(57) ABSTRACT

According to one embodiment, a content reproduction device connected through a network to a content server comprises a content acquisition module configured to function as a server for a client computer which retrieves to select content registered in the content server and to acquire the content selected by the computer from the content server, and a signal processing module which decodes the content acquired by the content acquisition module, wherein the content acquisition module acquires a uniform resource locator (URL) of the selected content to be reported from the computer and acquires content registered in the URL from the content server.

### CROSS-REFERENCE TO RELATED APPLICATIONS

This application is based upon and claims the benefit of priority from Japanese Patent Application No. 2008-290224, filed Nov. 12, 2008, the entire contents of which are incorporated herein by reference.

### BACKGROUND

1. Field

One embodiment of the invention relates to a content reproduction device and a content reproduction method configured to reproduce content registered in a content server on a network.

2. Description of the Related Art

In recent years, services which distribute content of moving images and still images for personal computers have become widely used. In general, since this content (web content) is encoded through a desired CODEC to be registered in Web sites, the personal computers are provided with various CODECS to be installed, for example, as application software. When desired content is distributed from the Web sites, this content is reproduced through decoding using one of the CODECs which have applied to encode the content among the CODECs.

In the case in which the content has been encoded through a special CODEC, a situation that it is hard to reproduce the content may be solved only by installing new application software corresponding to the special CODEC. Since personal computers are equipped with a variety of user interfaces for information inputs such as keyboards and mouse devices, the personal computers may easily retrieve and select the content. However, most of screens of the personal computers are small, so that users may not fully enjoy the content.

Meanwhile, digital household electrical appliances, such as network-compatible television devices, have become widely used. Such television devices are equipped with generic CODECS in order to enable viewing moving images and still images for personal computers; however, it is hard to add the special CODEC thereto.

Conventionally, a technique in which a transcoding server is disposed on the Internet, and the transcoding server transcodes content into a format of a CODEC which is usable for the digital household electronic equipment has been disclosed (see, e.g., Jpn. Pat. Appln. KOKAI Publication No. 2004-102339).

In the television devices, remote controllers are generally used as user interfaces for control operations and information inputting; however, the operability in retrieval and selection of content is not comfortable in comparison with the keyboards and mouse devices equipped with the personal computers. In such a situation, it is extremely complicated for the content server and transcoding server to be remotely controlled.

A style configured to supply a reproducing signal of the content from the personal computer to a television device with a large screen to view the content is a possible approach; however, the style has to connect the personal computer with the television device by a display cable in general. It should be noted that such “Wireless HD” is known as a standard to wirelessly connect the personal computer to the television device; however, in the present, the standard requires an increase in the cost under present circumstances, and it is unthinkable that the standard will be applied to all the personal computers in future. Primarily, since it is hardly possible that main uses of all the personal computers are not to reproduce the content of the moving images and still images to be distributed from the Web sites, it is proper to think that “Wireless HD” is a function to be mounted to a limited extent on a personal computer model which takes particular note of AV.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary view depicting a configuration of a network-compatible digital television device regarding one embodiment of the invention;

FIG. 2 is an exemplary view depicting a main signal processing system of the digital television (TV) device depicted in FIG. 1;

FIG. 3 is an exemplary view depicting a flow of processing for content reproduction by the digital TV device depicted in FIG. 1;

FIG. 4 is an exemplary view depicting communication between a personal computer (PC) and the TV device which is performed by using a POST method for reporting a URL depicted in FIG. 3;

FIG. 5 is an exemplary view depicting a format of a request body from the PC to the TV device depicted in FIG. 4;

FIG. 6 is an exemplary view depicting a format of a response body from the TV device to the PC depicted in FIG. 5;

FIG. 7 is an exemplary view depicting an operation procedure of the PC depicted in FIG. 3;

FIG. 8 is an exemplary view depicting a modified example of a flow of processing for content reproduction by the network-compatible digital TV device depicted in FIG. 3;

FIG. 9 is an exemplary view depicting communication in a reproduction preparation phase to be performed between a PC and a TV device for providing a media file (Web content) regarding the modified example depicted in FIG. 8;

FIG. 10 is an exemplary view depicting a format of a request body from the PC to the TV device depicted in FIG. 9;

FIG. 11 is an exemplary view depicting a format of a response body from the TV device to the PC depicted in FIG. 9;

FIG. 12 is an exemplary view depicting communication in a reproduction phase (transfer of Web content) to be performed between the PC and the TV device for providing the media file (Web content) regarding the modified example depicted in FIG. 8;

FIG. 13 is an exemplary view depicting a format of a response body from the TV device to the PC depicted in FIG. 12;

FIG. 14 is an exemplary view depicting communication in a reproduction phase (reproduction control) which is performed between the PC and the TV device for providing the media file (Web content) regarding the modified example depicted in FIG. 8;

FIG. 15 is an exemplary view depicting a format of a request body from the PC to the TV device depicted in FIG. 14;

FIG. 16 is an exemplary view depicting a format of a response body from the TV device to the PC depicted in FIG. 14;

FIG. 17 is an exemplary view depicting communication in a reproduction confirmation phase which is performed between the PC and the TV device in the media file (Web content) regarding the modified example depicted in FIG. 8;

FIG. 18 is an exemplary view depicting a format of a request body from the PC to the TV device depicted in FIG. 17; and

FIG. 19 is an exemplary view depicting a format of a response body from the TV device to the PC depicted in FIG. 17.

### DETAILED DESCRIPTION

Various embodiments according to the invention will be described hereinafter with reference to the accompanying drawings.

According to one embodiment of the invention, there is provided a content reproduction device connected through a network to a content server, comprising: a content acquisition module configured to function as a server for a client computer which retrieves to select content registered in the content server, and to acquire the content selected by the computer from the content server; and a signal processing module configured to decode the content acquired by the content acquisition module, wherein the content acquisition module acquires a uniform resource locator (URL) of the selected content to be reported from the computer and acquires content registered in the URL from the content server.

According to one embodiment of the invention, there is provided a content reproduction method for use in a content reproduction device connected through a network to a content server, comprising: causing the content reproduction device to function as a server for a client computer which retrieves to select content registered in the content server; acquiring a uniform resource locator (URL) of the selected content reported by the computer; acquiring content registered in the URL from the content server; and decoding the acquired content by the content reproduction device.

In the content reproduction device and the content reproduction method, retrieval to select content registered in the content server is performed on a side of the computer. The content reproduction device acquires a URL of content reported from a computer to acquire content registered in the URL from the content server. Therefore, a keyboard, mouse and the like on the computer side are usable in retrieval to select the content as a user interface for the content reproduction device, instead of generic remote controllers enables retrieval to select the content. Thus, the operability for reproducing the content registered in the content server on the network through a large screen can be improved.

A network-compatible digital TV device according to one embodiment of the invention will be described below. The digital TV device is, for example, a local area network (LAN)-connectable IPTV which is compatible with a TV content service using the Internet.

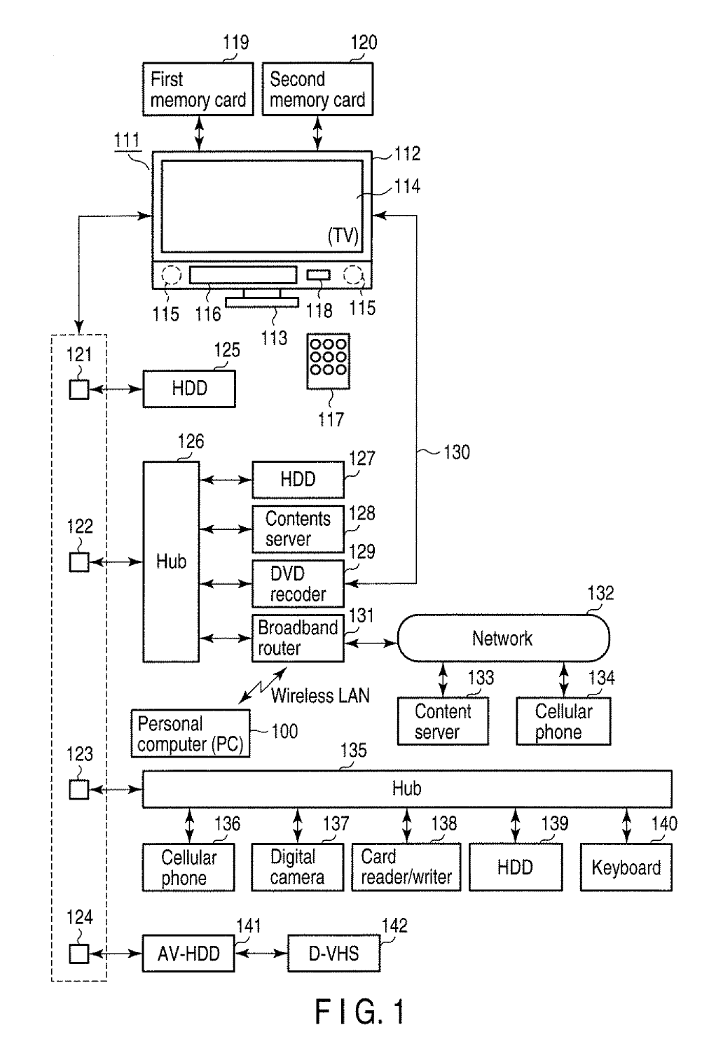

FIG. 1 schematically shows a configuration of a network-compatible digital TV device 111.

That is, the digital TV device is composed mainly of a low-profile cabinet 112, and a support base 113 standing up to support the cabinet 112. The cabinet 112 is provided, for example, with a plane-panel-type video display device 114 composed of a surface-conduction electron-emitter display (SED) display panel and a liquid crystal display panel, etc., a loudspeaker 115, an operation module 116, and a light reception module 118 receiving operation information to be transmitted from a remote controller 117.

A first memory card 119, for example, a Secure Digital (SD) memory card, a Multimedia Card (MMC) and a Memory Stick are detachably connected to the digital TV device 111, and information such as a program and a photograph can be recorded and reproduced on and from the first memory card 119.

Further, a second memory card (IC card) 120, for example, with contract information recorded thereon is detachably connected to the digital TV device 111, and information can be recorded and reproduced on and from the second memory card 120.

The digital TV device 111 is provided with a first local area network (LAN) terminal 121, a second LAN terminal, a universal serial bus (USB) terminal 123 and an i-LINK terminal 124.

Among of them, the first LAN terminal 121 is used as a LAN-compatible HDD exclusive port, and used for recording and reproducing information through Ethernet (registered trademark) in and from a LAN-compatible HDD 125.

Like this way, providing the first LAN terminal 121 as the LAN-compatible HDD exclusive port enables stably recording information of a program in a high-definition image quality in the LAN-compatible HDD 125 without being influenced on other network environments and network user situations.

The second LAN terminal 122 is used as a generic LAN-compatible port using Ethernet (registered trademark), and is used, for example, for connecting devices such as a LAN-compatible HDD 127, a content server 128, and a digital versatile disk (DVD) recorder 129 with a built-in HDD to perform information transmission to these devices.

The content server 128 is configured as a universal plug-and-play (PnP)-compatible device which has a function of operating as a server device of content in a network for one's home and further has a service for providing uniform resource identifier (URI) information which is necessary to access content.

As regards the DVD recorder 129, since the digital information to be communicated through the second LAN terminal 122 is information only for a control system, there is a need to dispose an exclusive analog transmission path 130 in order to transmit an analog video and voice information to and from the digital TV device 111.

Further, the second LAN terminal 122 is connected, for example, to a network 132 such as the Internet through a broadband router connected to a hub 126, and is used in order to transmit information to a content server 133 and a cellular phone 134, etc., via the network 132.

The content server 133 is disposed on the internet by a content provider, and is configured so as to operates as a server device disclosing Web sites with various content registered therein and distributing the content from the Web sites, and further, to operate as a UPnP-compatible device with a service providing URI information which is necessary to access the content.

The USB terminal 123 is used as a generic USB-compatible port, and is used, for example, in order to connect a USB device such as a cellular phone 136, a digital camera 137, a card reader/writer 138 for a memory card, a HDD 139, and a keyboard 140 through a hub 135 and is used in order to transmit information to these USB devices.

Further, the i-LINK terminal 124 is serially connected, for example, to an AV-HDD 141, a digital-Video Home System (VHS) 142, etc., and is used to transfer information to and from these devices.

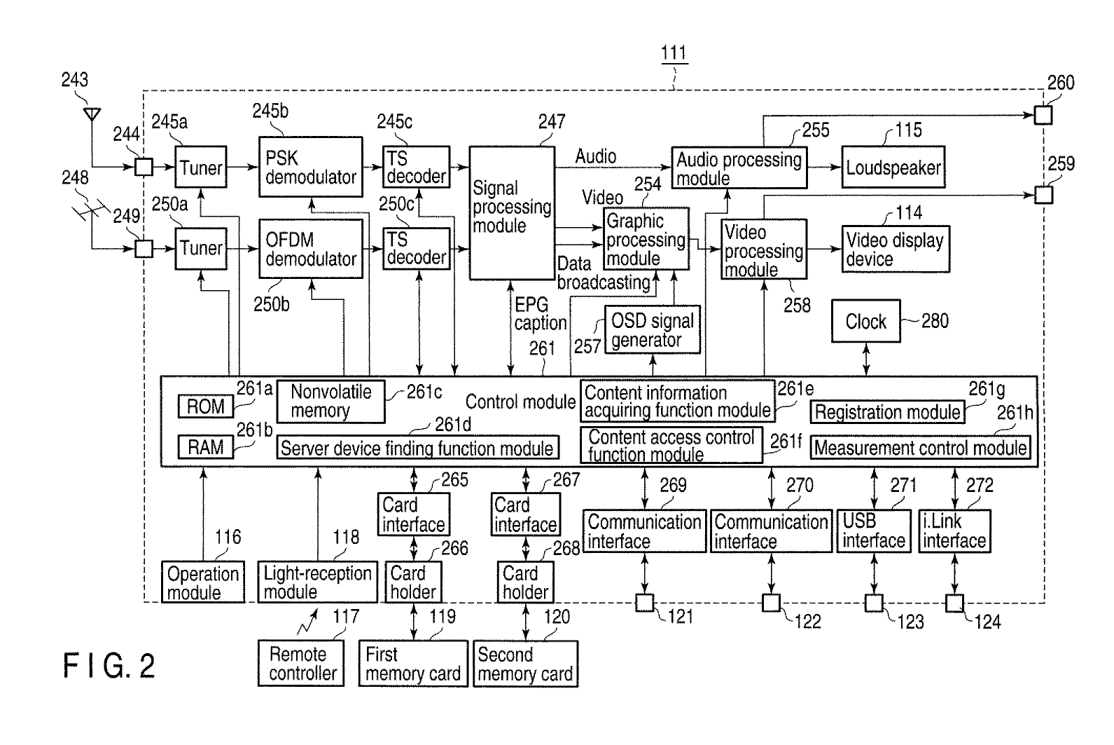

FIG. 2 shows main signal processing systems of the digital TV device 111.

That is, a satellite digital TV broadcasting signal received by an antenna 243 for digital DBS reception is supplied to a tuner 245a for satellite digital broadcasting through an input terminal 244.

The tuner 245a tunes a broadcasting signal in a desired channel by means of a control signal from a control module 261 to output the tuned broadcasting signal to a phase shift keying (PSK) demodulator 245b.

The PSK demodulator 245b demodulates the broadcasting signal tuned by the tuner 245a through the control signal from the control module 261, and obtains a transport stream (TS) including a desired program to output the stream to a TS decoder 245c.

The TS decoder 245c executes TS-decoding processing of a signal TS-multiplexed by the control signal from the control module 261, and outputs a packetized elementary stream (PES) obtained by de-packeting the digital video signal and audio signal of the desired program to an STD buffer 247f in a signal processing module 247.

The TS decoder 245c outputs section information transmitted through a digital broadcasting to a section processing module 247h in the signal processing module 247.

A terrestrial digital broadcasting signal received by an antenna 248 for terrestrial broadcasting reception is supplied to a tuner 250a for terrestrial digital broadcasting through an input terminal 249.

The tuner 250a tunes a broadcasting signal in a desired channel through the control signal from the control module 261 to output the tuned broadcasting signal to an orthogonal frequency division multiplexing (OFDM) demodulator 250b.

The OFDM demodulator 250b demodulates the broadcasting signal tuned by the tuner 250a through the control signal from the control module 261, and obtains a TS including a desired program to output the TS to the TS decoder 250c.

The TS decoder 250c executes the TS decoding processing of the signal TS-multiplexed by the control signal from the control module 261, and outputs a PES obtained by de-packetizing the digital video signal and audio signal of the desired program to the STD buffer 247f in the signal processing module 247.

The TS decoder 250c outputs section information transmitted through the digital broadcasting to the section processing module 247h.

Here, the signal processing module 247, during TV viewing, selectively applies prescribed digital signal processing to the digital video signal and audio signal supplied from the TS decoder 245c and the TS decoder 250c, respectively, to output the processed video signal and audio signal to a graphic processing module 254 and an audio processing module 255, receptively. During content reproduction, the signal processing module 247 selects a signal of content input from the control module 261, applies digital signal processing to decode the signal of the content on the basis of one CODEC suitable to the content among various CODECs to output the decoded signal to the graphic processing module 254 and the audio processing module 255.

Various items of data, electronic program guide (EPG) information, program attribute information (program category, etc.) and caption information, etc., (service information, SI, PSI) for acquiring a program are input in the control module 261 from the signal processing module 247.

The control module 261 executes image generation processing in order to display the EPG and caption from the input information to output the generated image information to the graphic processing module 254.

The section processing module 247h outputs various items of data, EPG information, program attribute information (program category information, etc.), and caption information (service information, SI, PSI) for acquiring a program among the section information input from the TS decoder 245c (250c) to the control module 261.

The graphic processing module 254 includes a function of combining (1) a digital video signal supplied from an AV decoder in the signal processing module 247, (2) an on-screen display (OSD) signal generated from an OSD signal generation module 257, (3) image data through a data broadcasting, and (4) the EPG and caption signals generated from the control module 261 to output the combination to a video processing module 258.

When displaying the caption through the caption broadcasting, the graphic processing module 254 overlapping capture information on a video signal on the basis of the capture information by means of the control from the control module 261.

The digital video signal output from the graphic processing module 254 is supplied to a video processing module 258. After converting the video signal into an analog video signal in a format which is displayable on the display device 114, the video processing unit 258 outputs the analog video signal to the video display 114 so as to video-display it and also derives the analog video signal outside through an output terminal 259.

After converting the input digital audio signal into an analog audio signal in a format which is reproducible from the loudspeaker 115, the audio processing module 255 outputs the analog audio signal to the loudspeaker 115 so as to audio-reproduce it and also derives the analog audio signal outside through an output terminal 260.

Here, the digital TV device 111 is integrally controlled its entire operations including the aforementioned various reception operations by means of the control module 261. The control module 261 has a built-in CPU, etc., receives the operation information from the operation module 116, or receives the operation information transmitted from the remote controller 117, and controls each module so that the operation content is reflected to each module of the TV device 111.

In this case, the control module 261 mainly utilizes a read-only memory (ROM) 261a with a control program to be executed by the CPU stored there in, a random access memory (RAM) 261b providing a work area to the CPU, and a nonvolatile memory 261c in which various setting information and control information are stored.

The control module 261 is connected to a card holder 266 capable of loading the first memory card 119 through a card interface 265. Thereby, the control unit 261 can transmit information through the first memory card 119 and the card interface 265 loaded on the card holder 266.

Further, the control module 261 is connected to a card holder 268 capable of loading the second memory card 120 through a card interface 267. Thereby, the control unit 261 can transmit information through the second memory card 120 and the card interface 267 loaded on the card holder 268.

The control module 261 is connected to the first LAN terminal 121 through a communication interface 269. Thereby, the control module 261 can transmit information through the LAN-compatible HDD 125 and the interface 269 connected to the first LAN terminal 121. In this case, the control module 261 includes a Dynamic Host Configuration Protocol (DHCP) server function and assigns Internet Protocol (IP) addresses to the LAN-compatible HDD 125 connected to the first LAN terminal 121 to control the HDD 125.

Further, the control module 261 is connected to the second LAN terminal 122 through a communication interface 270. Thereby, the control module 261 can transmit information through each device (see FIG. 1) connected to the second LAN terminal 122 and through the interface 270.

The control module 261 is connected to the USB terminal 123 through a USB interface 271. Thereby, the control module 261 can transmit information through each device (see FIG. 1) connected to the USB terminal 123 and through the USB interface 271.

Further, the control module 261 is connected to the i-LINK terminal 124 through an i-LINK interface 272. Thereby, the control module 261 can transmit information through each device (see FIG. 1) connected to the i-LINK terminal 124 and through the i-LINK interface 272.

Meanwhile, in this embodiment, the LAN-compatible HDD 125 record and stores a registration file with storage IDs (including IP addresses and device names), which are assigned for initially registering to the HDD 125, HDD 127, content server 128 and DVD recorder 129, respectively, described therein in the LAN compatible HDD 125.

The nonvolatile memory 261c stores each storage ID of the HDD 125, HDD 127, content server 128 and DVD recorder 129.

The control module 261 includes the following functions regarding the invention (1) a server device finding function module 261d through the use of UPnP; (2) a content information acquisition function module 261e through the use of UPnP; and (3) a content access control function module 261f.

(1) The control module 261 finds any UPnP-compatible device on the network by using a discovery function by means of the finding function module 261d. For instance, the finding function module 261d finds the content server 128 by using the discovery function of the UPnP.

(2) The control module 261 controls the UPnP-compatible device by using the control function of the UPnP by means of the content information acquisition function module 261e, and acquires URI information necessary for accessing the content in the UPnP-compatible device. For instance, the information acquisition function module 261e controls the content server 128 to acquire the URI information necessary for accessing the content stored in the HDD, etc., from the content server 128.

(3) The control module 261 determines if the content can be accessed on the basis of the IP address information of the server device acquired by the finding function module 261d, the IP address information acquired from the URI information acquired by the acquisition function module 261e, and the IP address and net mask assigned to the LAN terminal 122 of the TV device 111. If it is determined that the content can be accessed, the control module 261 allows content access, but if it is determined that the control cannot be accessed, the control module 261 displays not to allow the content access the display 114 through the OSD.

(4) The control module 261 is configured to hold a reproduction-correspondence situation of the signal processing module 247 concerning the reproduction of the content, and to report to a PC 100 if it has been detected for the PC 100 to be connected through a LAN. This reproduction-compatible situation includes, for example, kinds of usable CODECs.

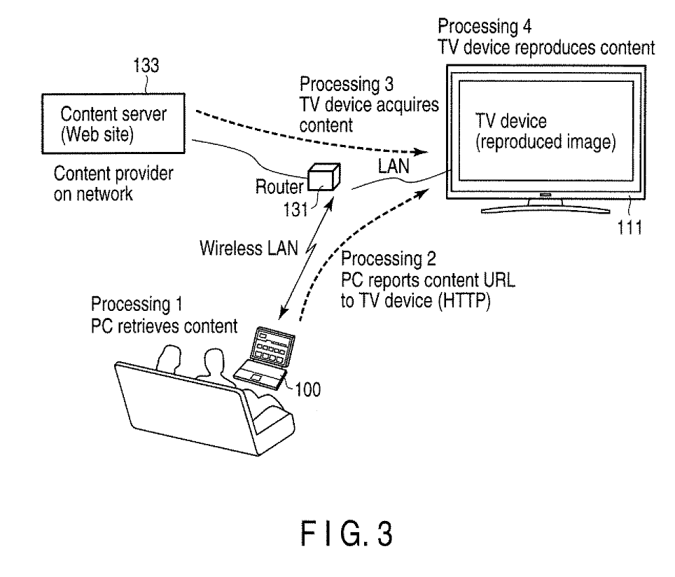

FIG. 3 shows a flow of processing for content reproduction by means of a network-compatible digital TV device.

In “processing 1” shown in FIG. 3, the PC 100 retrieves the content. More specifically, a user firstly operates to retrieve and select Web content through the PC 100. The retrieval and selection are executed by utilizing a Web service provided from the Web site of the content server 133 with the Web content such as moving images and photographs registered therein. It should be noted that the Web service to be provided in the Web site of the retrieval server which has linked to the Web content may be used. The user may retrieve and select favorite content though such retrieval of the Web service and selection function (GUI, etc.) and specify as Web content so as to display on a large screen of the TV device 111. In the drawing, the broadband router 131 includes a wireless LAN access point and a modem or equivalent device for accessing the Internet, whereby the PC 100, by connecting to the wireless LAN access point via wireless LAN, can access the Web site of the content server 133.

In “processing 2” shown in FIG. 3, the PC 100 reports the URLs of the content to the TV device 111. That is, the PC 100 reports the URLs of the moving images and photographs of the specified Web content to the TV device 111 via the LAN. Here, a communication protocol of a low-level layer such as a physical layer of a network protocol is defined as Ethernet (registered trademark), a communication protocol of the high-level layer (a network layer, etc.) is defined as TCP/IP, and a communication protocol of the further-high-level layer is defined as HTTP.

To transmit the data in the HTTP protocol, the TV device 111 is set as an HTTP server, and the PC 100 is set as its client. In the TV device 111, an HTTP server function is achieved by using a part of the control module 261. Setting the HTTP server in the PC 100 is also possible approach; however, in this case, in general, there is a need to consider the security of the PC 100. That is, to operate the PC 100 as the HTTP server, the user has to set concerning the security and it takes a great deal of time to install application software achieving the HTTP server function in the PC 100. Therefore, in the embodiment, the TV device 111 is set as a server. Here, limiting the function of the HTTP server set to the TV device 111 to the processing to be described in the embodiment prevents holes in the security as much as possible. While the HTTP server of the TV device 111 may be configured to always operate, the HTTP server may be configured to control and operate the TV device 111 through the operation of the remote controller, etc., for reproducing the content.

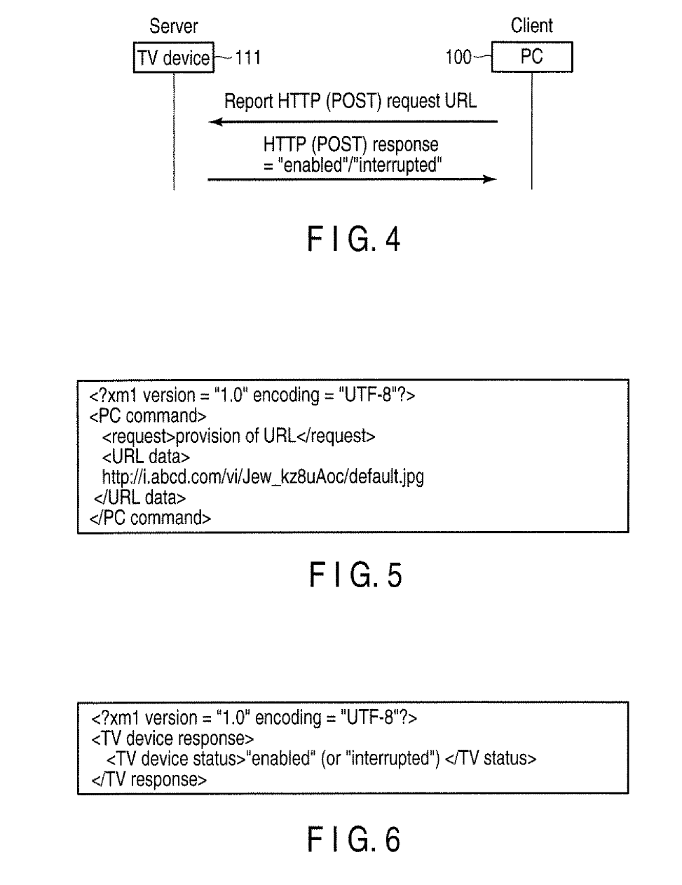

FIG. 4 shows communication between the PC 100 and the TV device (HTTP server) 111 to be performed by using a POST method. FIG. 5 shows a format of a request body from the PC 100 to the TV 111, and FIG. 6 shows a formation of a response body from the TV 111 to the PC 100.

As shown in FIG. 4, the PC 100 firstly reports the URL of the Web content specified by the request body of the HTTP (POST). The TV device 111 responses a status code of “200” or “except 200” to the foregoing request. The message body of the HTTP request and the response is, as shown in FIGS. 4 and 5, defined as an XML 1.0 well-formed XML document (without schema description). If the TV device 111 is in a state capable of receiving the URL of the Web content, the TV device 111 responds the status code “200”. Conversely, if the TV device 111 is a state not capable of receiving the URL (but, HTTP server is in operation), the TV device 111 responds the status code “except 200”.

Here, the case in which the status code is “200” will be described.

In this case, the PC 100 determines as follows in accordance with a TV status in the response body.

TV status=“enabled”: The TV device 111 succeeds in receiving data of the URL and can shift to processing 3 by which the TV device 111 obtains the content (media file) registered in this URL from the Web site of the content server 133.

TV status=“interrupted”: The TV device 111 succeeds in receiving the data of the URL; however, the HTTP (POST) response is “BUSY” and the TV device 111 cannot shift to the processing “3”. In this case, the PC 100 executes an error display like “Confirm TV status”. That is, this error display means that the TV device 111 cannot execute reproduction of the specified Web content due to a certain cause. This “interruption” occurs, in cases, for example, in which (1) the communication using the LAN can be made between the TV device 111 and the PC 100, but the TV device 111 cannot access the Web site of the Web server 133 concerning the received URL from the TV device 111; (2) the TV device 111 is in execution of video-recording of a program in a different channel, etc., and cannot secure a resource executing the reproduction of the Web content; and (3) the TV device 111 is out of order.

If the status code of the response indicates “except 200”, the PC 100 continues the re-transmission of the request as long as possible, and executes an error display (HTTP status code display) in a situation in which the re-transmission of the request is disabled from being continued.

In “processing 3” shown in FIG. 3, the TV device 111 obtains the content. For instance, in the case in which a URL (http://i.abcd.com/vi/Jew_kz8uAoc/default.jpg) as is shown in FIG. 4 is reported to the TV device 111, the TV device 111 accesses the Web site of the content server 133 related to this URL. An access method after obtaining the URL is the same as a conventional access method for performing in the case where the TV device 111 obtains the URL as a selection result of the Web content. The URL shown in FIG. 5 is an example of the case in which content of image data of “default.jpg” is obtained from a server of a host name of “i.abcd.com” in an http scheme. While a protocol for providing the content from the Web site of the content server 133 is frequently the HTTP protocol in general, the invention is not limited to this example.

In “processing 4” shown in FIG. 3, the decoder in the TV device 111 reproduces (reproduces JPEG-compressed images) the Web content (image data as “default.jpg” in an example of FIG. 5) such as moving images and photographs captured in the processing 3 by means of the TV device 111, and displays the Web content on the video display 114 with the large screen.

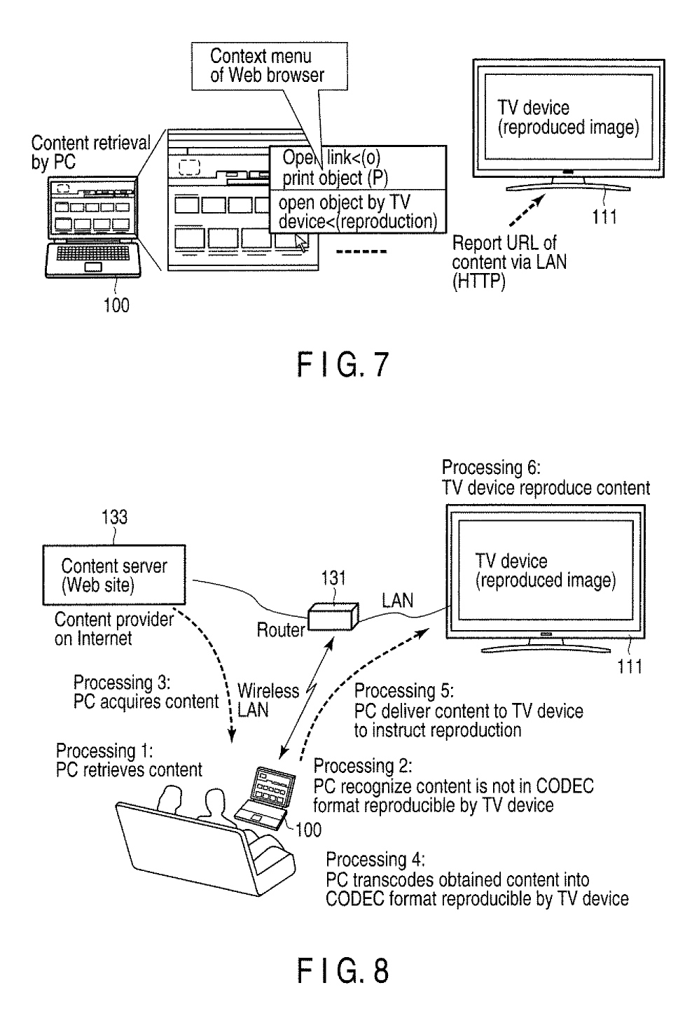

FIG. 7 shows an operation procedure of the PC 100 shown in FIG. 3. The PC 100 selects one item of content on a screen retrieving the Web content. Usually, the PC 100 uses application software displaying a Web page called a Web browser. The Web browser is also called an Internet browser, although a large number of browsers are developed, the invention is not limited to the given embodiment.

In the case in which one item of content is selected on a Web page shown in FIG. 7, when a right-click operation of a mouse (in FIG. 7, a pointer of a mouse is put on a lower-right thumbnail-size image in a Web page and a right-click operation is performed) is executed on a selected content (a lower-right thumbnail-size image or a character string to which a link destination of a moving image is hyper-linked), a context menu of a Web browser is displayed as shown in FIG. 7. The context menu shows a menu list including “open object by TV device (reproduction)”, which is a menu for setting Web content as the object to be reproduced by the TV device 111.

When the user selects this menu “open object by TV device (reproduction)”, the PC 100 reports the URL of the content to the TV device 111 as mentioned for FIG. 3.

Since functions to report a context menu of the Web browser shown in FIG. 7, and to report the URL of the content to the TV device 111 as described for FIG. 3 are not standard functions, these function are achieved by adding application software (PC application) to the PC 100.

In FIGS. 3, 4, if the content is a moving image, the URL to be reported to the TV device 111 is not a URL (e.g., http://i.abcd.com/xyz.jpg) of a thumbnail still image which has been displayed on the Web browser, but a URL (e.g., http://i.abcd.com/xyz.mpeg) reporting a moving image itself. Therefore, a PC 100 side determines if the URL to be reported to the TV device 111 is the moving image. That is, the URL to be reported to the TV device 100 determines the following (1) or (2) through the PC application and further determines whether (2a) or (2b) if the TV device 100 determines the following (2):

(1) In the case where there is no link destination (hyper-linked URL) in a display still image: URL of a display image (still image);

(2) In the case where there is a link destination in a display still image;

(2a) A link destination is a moving image: URL of a link destination (moving image); and

(2b) Other than the above: URL of a display image (still image).

The determination if the content is the moving image is performed on the basis of an extension of a link destination file name. If the link destination file names each have extensions such as “.mpg”, “.mpeg”, “.m2p”, “.mp2”. “.m2t”, “.m2ts”, “.ts”, “.tts”, and “.mp4”, it is determined the content is the moving image. However, the extensions of these file names are examples, the extensions may be set by the PC application.

The Web content has inclinations to develop and adopt new encode systems of video and audio one right after the other. However, in general, the function of the TV device 111 is built-in type, and it is hard to correspond to the new encode systems of the video and audio.

In the embodiment of the above, the retrieval and selection of the content registered in the content server 133 are implemented on the PC side. The content reproduction device obtains the URL of the content to be reported from the PC 100, and obtains the content registered in the URL from the content server 133. Accordingly, the embodiment makes it possible to use a keyboard and a mouse on the PC side 100 as a user interface of the TV device 111 as substitute for the generic remote controller 117. Thus, the operability in the case where the content registered in the content server on the network is reproduced on a large screen may be improved.

FIG. 8 shows a modified example of a flow of processing for content reproduction by means of the network-compatible digital TV device shown in FIG. 3. This modified example is composed in a similar manner of the embodiment of the above except items mentioned hereinafter.

In “processing 1” shown in FIG. 8, the PC 100 retrieves the content in a similar manner of the embodiment described above. More specifically, the user firstly retrieves to select the Web content through the PC 100. The operations are the same as those of FIG. 3 until the Web content, which is desired to be displayed on the large screen of the video display device 114, will be selected.

In “processing 2” shown in FIG. 8, it is recognized that the CODEC of the Web content selected by the PC 100 is not in a format of a CODEC which is usable by the TV device 111. Here, the CODEC includes not only a compression method (e.g., MPEG2, MPEG4/H.264, etc.) for video audio data of the Web content but also a file format for putting together the compression and coded video audio data as one file. That is, a series of decode processing methods and their rules from extraction of the compressed and coded video audio data from the Web content provided from the Web site up to reproduction are deemed as the CODEC.

In the case in which the selected content is in a format of a CODEC usable for the TV device 111, the PC 100 shifts to the processing after “processing 2” shown in FIG. 3. If the selected content is not in a format of a CODEC not usable for the TV device 111, the PC 100 shifts to the processing after “processing 3” shown in FIG. 8. In “processing 2”, either system of obtaining to analyze a part or all items of the Web content selected by the PC 100 and determining on the basis of the comparison between the analysis result and the reproduction correspondence situation on the TV device 111 side, or a system of determining on the basis of the comparison between OECD information of the Web content provided on a screen for retrieving the Web content, namely the Web content provided on the Web content, and a reproduction correspondence situation on the TV device side 111 may be applied.

It should be noted that, in the case in which the PC 100 knows in advance the information on the CODEC usable by the TV device 111 as the reproduction correspondence situation, to make determination, the TV device 111 may determine after the PC 100 communicates with the TV device 111 and after the PC 100 acquires the information of the CODEC usable by the TV device 111.

In “processing 3” shown in FIG. 8, the PC 100 executes to all the Web content of which the format is confirmed not to be the CODEC format usable for the TV device 111. Here, The PC 100 obtains all items of the Web content from the content server 133.

In “processing 4” shown in FIG. 8, the Web content which has obtained by the PC 100 is transcoded into the format of the CODEC usable by the TV device 111.

“Processing 3” and “processing 4” may obtain TV device 111 the specified entire Web content and may shift to the following “processing 5” after transcoding; however, they may obtain a part of the beginning items of the Web content, may obtain the remaining web content continuously in a state of completion of the transcoding, and may shift to “processing 5” while transcoding.

In “processing 5” shown in FIG. 8, the TV device 111 provides the Web content which has been transcoded from the PC 100 to the TV device 111 and issues a reproduction instruction through the LAN. Also in this case, like the case shown in FIG. 3, a low-level layer such as a physical layer of a network protocol is defined as Ethernet, and a communication protocol on a high-level layer (network layer, etc.) is defined as TCP/IP, and the protocol of a further-high-level layer is defined as HTTP.

Also in this modified example, since the data is transmitted through the HTTP protocol, the TV device 111 is set as the HTTP server, and the PC 100 is set as its client. In the TV device 111, the HTTP server function is actualized by using a part of the control module 261. Although setting the HTTP server to the PC 100 is a possible approach, in this case, it is generally necessary to consider the security of the PC 100. That is, making the PC 100 operate as the HTTP server needs to execute setting concerning the security, and this setting takes a great deal of time for installing the PC application achieving the HTTP server into the PC 100. Therefore, in the embodiment, the TV device 111 is set as a server. Here, limiting the function of the HTTP server set in the TV device 111 to the processing described in the embodiment prevents the occurrence of weakness in security as much as possible. The HTTP server on the TV device 111 may be configured to always operate; however, the HTTP server may be configured to operate by controlling the TV device 111 due to operations of the remote controller, etc., for reproducing the content.

In provision of media files (Web content), communication is made between the PC 100 and the TV device (HTTP server) 111 in a POST method. This communication may be divided into three phases of a reproduction preparation phase, a reproduction phase, and a reproduction confirmation phase.

[Reproduction Preparation Phase]

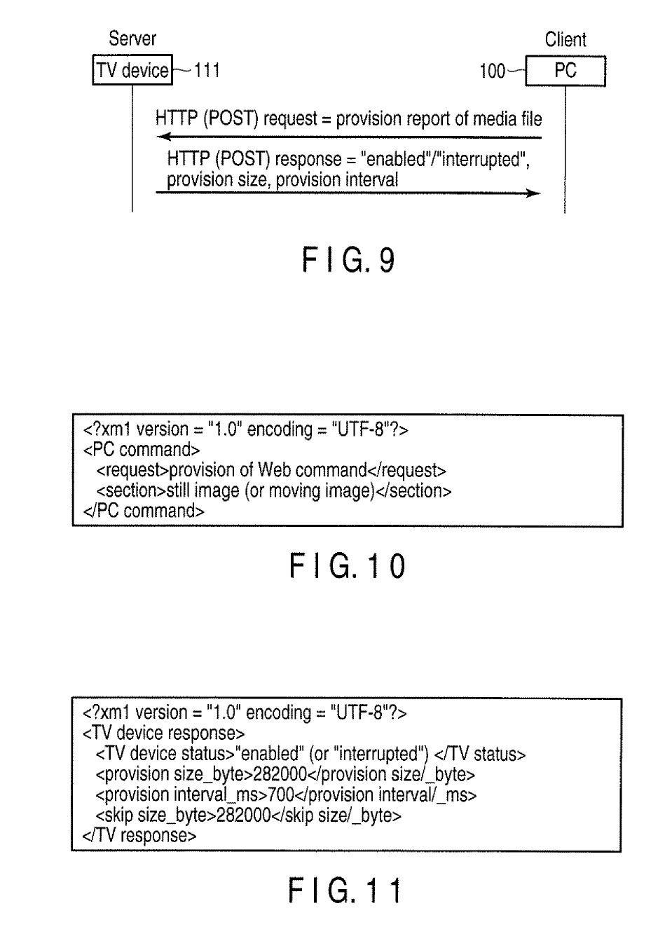

FIG. 9 shows communication of reproduction preparation phase to be performed between the PC 100 and the TV device (HTTP server) 111. FIG. 10 shows a format of a request body from the PC 100 to the TV device 111, and FIG. 11 shows a format of a response body from the TV device 111 to the PC 100. The described numeric values indicate examples.

The PC 100 reports the desire to provide and reproduce the transcoded Web content which has owned and reports the kind (moving image/still image) of the Web content to the TV device 111.

In the case of “200” of a status code of a response, the PC 100 determines as follows in accordance with the TV status in the response body.

TV status=“enabled”: the TV device 111 succeeds in receiving a command and enables shifting to the reproduction phase of the Web content.

TV status=“interrupted”: Although the TV device 111 succeeds in receiving the command, the TV device 111 is in “BUSY” then the PC 100 cannot sift to reproduction of the Web content. In this case, the PC 100 performs an error display such as “confirm a TV status”. That is, it means that the TV device 111 cannot execute to reproduce the specified Web content because of some reasons. This “interruption” occurs, for example, (1) in the case where the TV device 111 is under execution of recording of a program on a different channel, and may not secure a resource to execute the reproduction of the Web content, or (2) in the case where the TV device 111 is out of order.

In the response, a provision size (byte), a provision interval (ms), and a skip size (byte) other than the foregoing TV statuses.

The PC 100 prepares the Web content provision in accordance with the provision size (byte) and the provision interval (ms). The provision size and the provision interval are set in response to the kind of the Web content and the specification of the TV device 111 side.

The definition of the provision interval is an interval to “POST” the Web content divided by the provision size. More specifically, the provision interval is a time interval in which the PC 100 starts the last “POST” and starts the next “POST”. If the rate of the network is constant, the time interval becomes the same as the interval in which the TV device 111 receives the POST request.

If the Web content is moving image, the skip size (byte) is reported as a data size per second.

In the reproduction preparation phase, the TV device 111 has not received the Web content, and the provision size (byte), the provision interval (ms) and the skip size (byte) are reference values. The PC 100 should use the latest skip size (byte) after the reproduction phase.

In the case where the status code of the response is “except 200”, the PC 100 continues re-transmission of requests as long as possible to perform an error display (HTTP status code display) in a situation in which the re-transmission of the requests is disabled.

[Reproduction Phase]

In communication of a reproduction preparation phase, it is necessary for the TV status of the response from the TV device 111 is “enabled”.

In the reproduction phase, two types of communication such as transference and reproduction control of the Web content are performed as described below.

Reproduction Phase (Transference of Web Content)

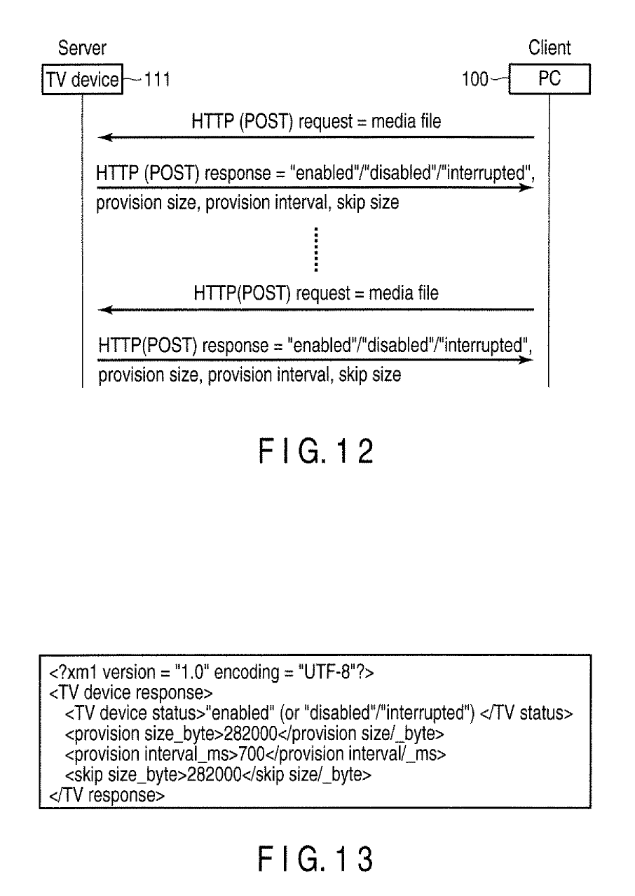

FIG. 12 shows communication of a reproduction phase (transference of Web content) between the PC 100 and the TV device (HTTP server) 111. The request from the PC 100 to the TV device 111 includes the Web content with the provision size (byte). FIG. 13 shows a formation of a response body from the TV device 111 to the PC 100. The described numeric values are indicates examples

The PC 100 “POSTs” the Web content by the provision size and at provision intervals specified by the TV device 111 in the reproduction preparation phase.

If the status code of the response is “200”, the PC 100 determines in accordance with the TV status in the response body as described below.

TV status=“enables”: the section of the Web content data has succeeded.

TV status=“disabled”: the TV device 111 is in “BUSY”, and the PC 100 should “POST” the same status again.

TV status=“interrupted”: the TV device 111 is in “BUSY”, and the PC 100 should perform an error display to end the processing.

The provision size (byte) is a size of the Web content to be provided after the next time, and a use case will be described later.

The provision interval (ms) is a provision interval (timing) of the Web content to be provided after the next time, and a use case will be described later.

The skip size (byte) is a size in the case where the Web content is the moving image, a data size per second is reported.

In a message body of a response, the provision size (byte), the provision interval (ms) and the skip size (byte) are described other than the foregoing TV statuses.

In the case where the status code of the response is “except 200”, the TV device 111 continues re-transmission of the requests as long as possible to perform an error display (HTTP status code display) in a situation where the re-transmission of the requests are disabled. However; execution of the application is continued.

[Reproduction Phase (Reproduction Control)]

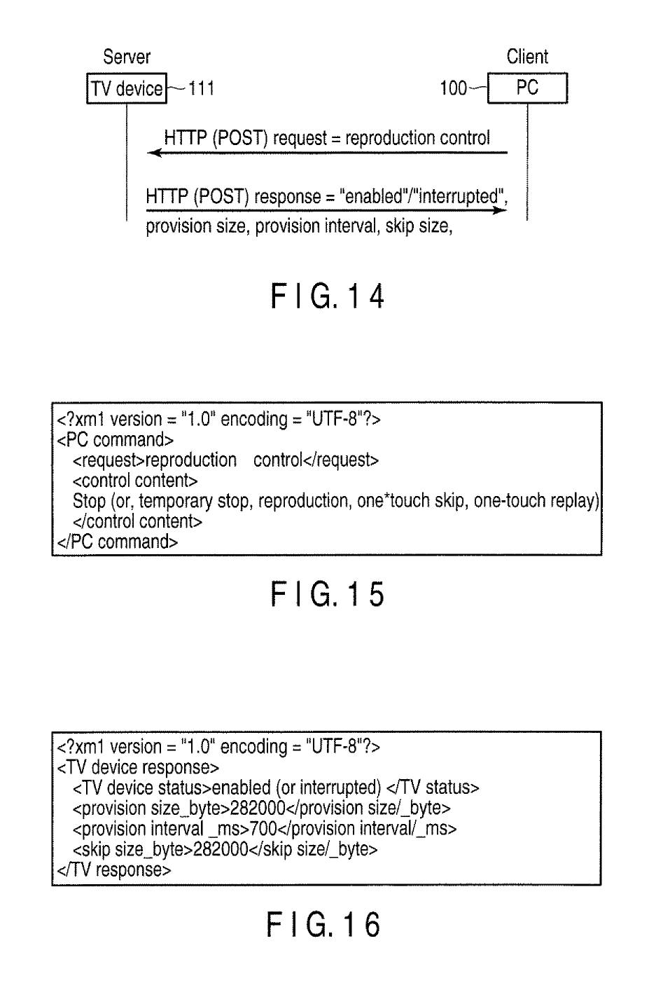

FIG. 14 shows communication in the reproduction phase (reproduction control) performed between the PC 100 and the TV device (HTTP server) 111. FIG. 15 shows a formation of a request body from the PC 100 to the TV device 111, and FIG. 16 shows a format of a response body from the TV device 111 to the PC 100. The described numeric values are examples.

The PC 100 “POSTs” the Web content by the provision size and at provision intervals specified by the TV device 111 in the reproduction preparation phase.

If the PC 100 desires to issue an instruction relating to the reproduction to the TV device 111, the PC 100 issues instructions as described below.

“Stop” indicates reproduction completion. Thereby the TV 111 ends a moving image reproduction application.

“Temporary stop” indicates to temporarily stop reproduction.

“Reproduction” indicates to release “temporary stop” and restart the reproduction.

“One-touch skip” skips for a time preset by the PC 100 to indicate a start of normal reproduction from the skipped time.

“One-touch replay” puts back by a time preset by the PC 100 to indicate a start of normal reproduction.

In accordance with the control from the PC 100, the TV device 111 operates as described below.

In the case of “stop”, the TV device 111 ends the moving image application, and a cooperation application between the PC 100 and the TV device 111 is continued.

In the case of “temporary stop”, the TV device 111 knows that the transference (POST) of the Web content is temporarily stopped and temporarily stops the reproduction of the content in the moving image application.

In the case of “reproduction”, the TV device 111 knows that the transference of the Web content is restarted and operates in response to a present status as described below.

In the case of “stop”, the TV device 111 waits for “POST” of the Web content to start reproduction of received Web content by activating the moving image reproduction application.

In the case of “temporary stop”, the TV device 111 restarts reproduction of content (reproduction is started from a temporary stop position).

In the case of “one-touch skip”, the TV device 111 knows that the data is not continued due to the transference (POST) of the Web content which will occur next, and when receiving the Web content from the next POST, the TV device 111 discards present data (non-reproduced part of data obtained before one-touch skip instruction), and uses newly obtained data to start reproduction.

In the case of “one-touch replay”, the TV device 111 knows that the data is not continued due to the transference (POST) of the Web content generated next, and when receiving the Web content from the next POST, the TV device 111 discards the present data (non-reproduced part of data obtained before one-touch replay instruction), and used newly obtained data to start reproduction.

In the case of a status code of a response is “200”, the PC 100 determines in accordance with the TV status in the message body as described below.

TV status=“enabled”: the TV device 111 has executed the instruction.

TV status=“interrupted”: the TV device 111 is in BUSY, and the PC 100 should perform an error display such as “confirm a TV status”.

In a message body of a response, the provision size (byte), the provision interval (ms), and the skip size (byte) are described other than the forgoing TV statuses.

If the status code of the response is “except 200”, in the case where re-transmission and continuation of requests are enabled, PC 100 retransmits and continues the requests, and in the case where the re-transmission and continuation of the requests are disabled, PC 100 ends the processing to perform an error display (HTTP status code display).

[Reproduction Confirmation Phase]

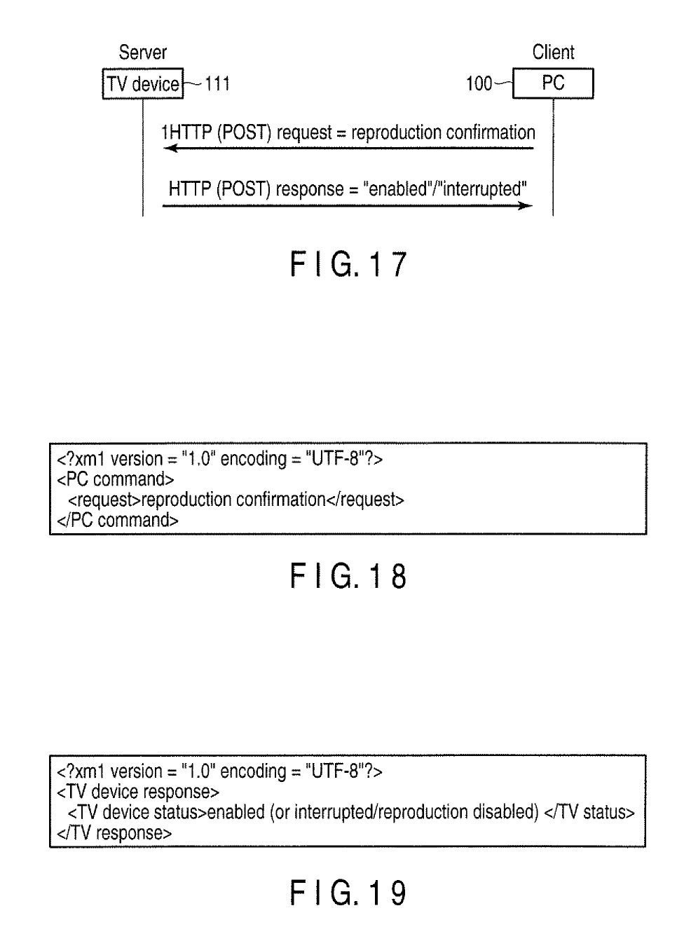

FIG. 17 shows communication of a reproduction confirmation phase between the PC 100 and the TV device (HTTP server) 111. FIG. 18 shows a format of a response body from the PC 100 to the TV device 111, and FIG. 19 shows a format of a response body from the TV device 111 to the PC 100.

When a plurality of times of communication are performed in the reproduction phase, while the PC 100 is able to recognize the reproduction situation of the TV device 111, if the communication is less performed in the reproduction phase, the PC 100 may not recognize the reproduction situation of the TV 111 since the TV device 111 is unable to generate a response indicating that reproduction is disabled (the TV detects that the Web content is in a format disabled from being reproduced).

After completion of the reproduction phase, the PC 100 performs communication of a reproduction confirmation phase to recognize the reproduction situation of the TV device 111.

If the status code of the response is “200”, the determination following the TV status in the message body by the PC 100 determines are:

TV status=“enabled”: The TV device 111 has been enabled from being reproduced.

TV status=“interrupted”: The TV device 111 is in BUSY, and the PC 100 should perform an error display such as “recognize a status of the TV device”.

If the status code of response is “except 200”, the PC 100 continues the re-transmission of the request as long as possible, and ends the processing in a situation where the re-transmission of the request cannot be continued to perform an error display (status code display).

The invention is not limited to the aforementioned embodiments, and various modification can be made without departing from the spirit or scope of the general inventive concept thereof.

In the embodiments of the above, while the network-compatible TV devices 111 are installed as content reproduction devices connected to the content servers 133, the invention is not limited to the embodiments. As regards one example, a set-top box may be configured as a set-top box which connects a network-incompatible television device equipped with an ordinary TV broadcasting reception circuit and a display device. In this case, the set-top box comprises a content acquisition module which functions as a server making the computer 100 retrieving to select the content registered in the content server 133 and acquires the content selected by the computer 100 from the content server 133; and a signal processing module which decodes the content acquired by the content acquisition module.

When the computer 100 retrieves to select the content registered in the content server 133, the content acquisition module of the set-top box acquires the URL of the selected content to be reported from the computer 100 to acquire the content registered in the URL from the content server 133.

The various modules of the systems described herein can be implemented as software applications, hardware and/or software modules, or components on one or more computers, such as servers. While the various modules are illustrated separately, they may share some or all of the same underlying logic or code.

While certain embodiments of the inventions have been described, these embodiments have been presented by way of example only, and are not intended to limit the scope of the inventions. Indeed, the novel methods any systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A content reproduction device connected through a network to a content server, comprising:
a content acquisition module configured to function as a server for a client computer which retrieves to select content registered in the content server, and to acquire the content selected by the computer from the content server; and
a signal processing module configured to decode the content acquired by the content acquisition module,
wherein the content acquisition module acquires a uniform resource locator (URL) of the selected content to be reported from the computer and acquires content registered in the URL from the content server.

2. The device of claim 1, wherein the content acquisition module further reports a reproduction correspondence situation including a kind of a CODEC usable by the signal processing module to the computer, and if it is determined by the computer that the signal processing module cannot reproduce the selected content on the basis of the reproduction correspondence situation, acquires content which is acquired from the content server by the computer, and which is provided through transcoding into a format of the CODEC usable by the signal processing module.

3. The device of claim 2, wherein the content acquisition module is connected to a router wirelessly connected to the computer.

4. The device of claim 3, wherein the content acquisition module is connected to the content server through the router.

5. The device of claim 3, wherein the content acquisition module functions as a Hyper Text Transfer Protocol (HTTP) server to communicate with the computer in a POST method.

6. The device of claim 1, wherein the device is a network-compatible television device.

7. The device of claim 1, wherein the device is a set-top box for connecting a television device to the network.

8. A content reproduction method for use in a content reproduction device connected through a network to a content server, comprising:
causing the content reproduction device to function as a server for a client computer which retrieves to select content registered in the content server;
acquiring a uniform resource locator (URL) of the selected content reported by the computer;
acquiring content registered in the URL from the content server; and
decoding the acquired content by the content reproduction device.

9. The method of claim 8, further comprising:
reporting a reproduction correspondence situation including a kind of a CODEC usable by the content reproduction device;
acquiring content, which is acquired from the content server by the computer, and which is reported through transcoding into a format of the CODEC usable by the signal processing module if it is determined by the computer that the content reproduction device cannot reproduce the selected content on the basis of the reproduction correspondence situation: and
decoding the acquired content by the content reproduction device.
